(19) United States
(12) Patent Application Publication
(10) Pub. No.: US 2009/0102619 A1
(43) Pub. Date: Apr. 23, 2009

(54) Evacuation System Having Escape Identification Lights

(76) Inventors: Franz Blohberger, Salzburg (AT); Gottfried Grundler, Salzburg (AU)

Correspondence Address: COLLARD & ROE, P.C., 1077 NORTHERN BOULEVARD, ROSLYN, NY, 11576, US

(21) Appl. No.: 11/883,953

(22) PCT Filed: Feb. 14, 2006
(86) PCT No.: PCT/AT2006/000053

§ 371 Date: Jul. 31, 2008

(30) Foreign Application Priority Data
Feb. 15, 2005 (AT) A 240/2005

(51) Int. Cl. G08B 5/00

(52) U.S. Cl. 340/332

(57) ABSTRACT

An evacuation system having escape identification lights (1) and monitoring sensors (2), having a central computing system (7) is suggested, which analyzes messages from the monitoring sensors (2) and alternately releases or blocks escape routes as a function thereof by targeted activation of building devices (12) and escape identification lights (1). To provide advantageous construction conditions, it is suggested that the escape identification lights (1) comprise a control unit (15), which may be coupled to a display (13) and is connected via a network (14) to the computing system (7), which is alternately connected to one or to at least two displays (13) via an interface (16) for activation.

### 1. FIELD OF THE INVENTION

The present invention relates to an evacuation system having escape identification lights, having monitoring sensors, and having a central computing system, which analyzes messages from the monitoring sensors and alternately releases or blocks escape routes as a function thereof by targeted activation of building devices and escape identification lights.

### 2. DESCRIPTION OF THE PRIOR ART

In buildings, ships, or the like, it must always be ensured by providing evacuation systems of this type that spatial areas and/or zones may be left by a large number of individuals without danger within the shortest possible time. Static signage may possibly lead streams of individuals into the actual danger area, because no targeted escape route guiding may be performed. This not only results in delays in the evacuation, but rather may also cause a panic outbreak among the individuals to be rescued.

To avoid this, a dynamic escape route guiding system has already been suggested (DE 196 44 127 B 4), the escape route signage being implemented as variable and adaptable to the particular hazard situation. Using this system, it is possible to react to greatly varying, possibly unpredictable situations with appropriate measures for evacuation, such as escape route signposts in particular. For this purpose, monitoring sensors are provided for object monitoring and for automatic danger recognition, identification, and localization, which relay any dangers to a central computing system. The central computing unit analyzes the incoming signals and subsequently calculates the most secure and/or rapid escape routes and alternately releases or blocks escape routes by targeted activation of building devices and escape identification lights. For this purpose, it may be necessary, for example, to activate ventilation systems, doors, elevators, escalators, or the like in the desired way. In particular the high outlay in wiring the system itself and the lack of expandability when extending the system are seen as disadvantageous in the known evacuation system, every escape identification light having to be activated individually by the computing system.

### SUMMARY OF THE INVENTION

The present invention is therefore based on the object of implementing an evacuation system and an associated escape identification light of the type described at the beginning in such a way that the above-mentioned disadvantages are avoided and a system which is expandable as simply as possible is provided with reduced hardware outlay.

The present invention achieves this object in that the escape identification light comprises a control unit which may be coupled to a display and is connected via a network to the computing system, and which is alternately connected to one or to at least two displays via interfaces for activation.

The possibility of minimizing the hardware outlay for escape identification lights with undiminished functional reliability, and simultaneously allowing dynamic escape route guiding, is provided in a simple way by the present invention, because if necessary one control unit for activating multiple displays, for example, of a room, hall, or zone, is possible. For this purpose, the displays are particularly advantageously to be activated via a wireless network from the control unit, which has the result that the displays solely have to be connected to a power supply. Alternatively, the displays may be activated from the interface via a typical cable, this cable also assuming the power supply for the displays in this case if needed, to avoid double connections. The displays are alternately connected via branch lines, a ring line, or in series to the control unit.

It is especially advantageous if the control unit for monitoring and programming is connected to at least one control computer via the computing system and the network, and a unique network identification is assigned to each control unit and each display. It is thus ensured that each escape identification light may be activated, monitored, and possibly programmed in a targeted way with little hardware outlay. An operator seated at the control computer may thus engage without problems in the evacuation system and release or block escape routes manually if needed and/or give instructions via loudspeakers to fleeing individuals or communicate with rescue units.

An escape identification light for use in an evacuation system having monitoring sensors and a central computing system for activating escape identification lights is distinguished by a control unit which may be coupled to the display and is connected via a network to the computing system, which is alternately connected to one or at least two displays via interfaces for the activation. The advantages of this procedure have already been described above.

It has been shown to be especially advantageous if the display and the control unit form a module removably connected to one another. Therefore, the possibility exists, for example, of either activating displays directly from a control unit equipped with a display or implementing the control unit as a desktop unit, or situating it in a switch cabinet or the like and activating the displays therefrom. By providing the two assemblies, the display and the control unit, which are connected to one another if needed, in particular screwed together, plugged in as a plug-in card, or plugged together, it is possible to cover multiple variants of mounting by providing only these two assemblies.

In principle, it is sufficient if the control unit comprises a preprogrammed memory or the like and it executes predefined commands in the event of specific occurring events and relays the corresponding signals to the displays. However, it is suggested that the control unit have a processor, a network interface, and a power supply unit having an emergency running device, because the control unit may be programmed especially simply from the central computing system and/or from the control computer in this case and may thus be tailored to new requirements, such as expansions, construction sites, or the like. An expansion of the displays connected to a control unit is thus possible without problems at any time.

Because of the architecture of the escape identification light according to the present invention, cameras and/or acoustic input and/or output devices may be integrated in an especially advantageous way into the system according to the present invention, the output signals of the camera and/or of the acoustic input and/or output devices possibly also being connected via the control unit to the network interface and thus data being able to be transmitted at any time to the central computing system and/or to the control computer, from where the operator may retrieve it and/or via which the operator may relay information to any fleeing individuals.

If the escape identification lights are equipped with additional lamps on the display or on the housing for illuminating the escape routes, the possibility results in a simple way of still ensuring sufficient lighting of the escape routes in the event of a power outage, because the escape identification lights are provided in a typical way with emergency running devices, which ensure functioning of the evacuation system over a predefined period of time. In addition, the lamps may include a controller for presetting the luminous intensity, to reduce the power demand by the lamps in the event of sufficient ambient light and thus ensure a longer residual runtime of the emergency running device.

In principle, the functionality of the escape identification lights may be queried by the central computing unit, error messages subsequently being fed to the control computer and thus to the operator. To relay any errors as rapidly as possible and also be able to react to errors of this type rapidly, it is advantageous if the control unit includes a diagnostic program, which immediately sends error messages, while specifying the network identification of the faulty module and the error, via the network interface to the computer unit and the control computer in the event of malfunctions.

### BRIEF DESCRIPTION OF THE DRAWING

The present invention is schematically illustrated on the basis of an exemplary embodiment in the drawing.

FIG. 1 shows a schematic diagram of an evacuation system according to the present invention,

FIG. 2 shows a module made of display and control unit of an escape identification light, and

FIG. 3 shows a diagram of the control unit.

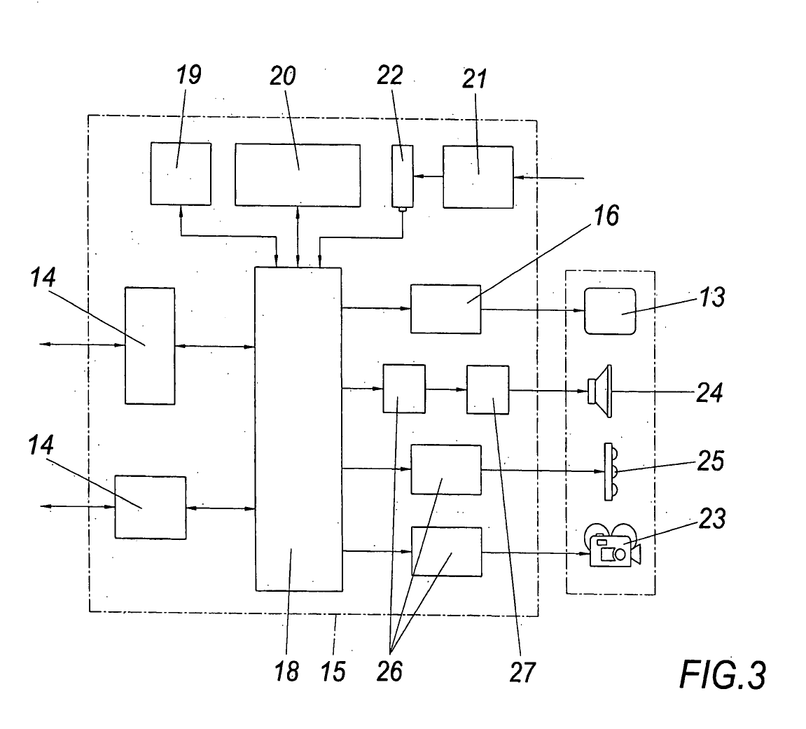

### DESCRIPTION OF THE PREFERRED EMBODIMENT

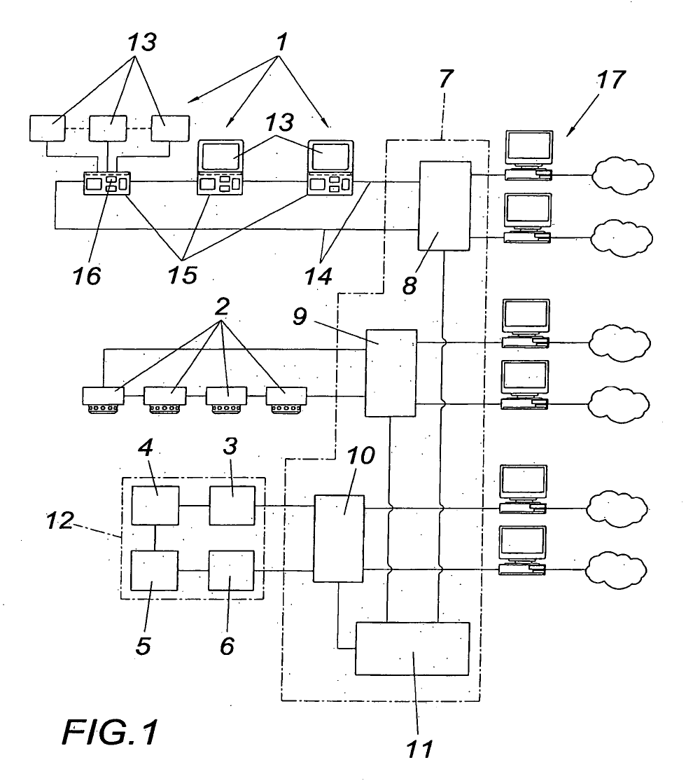

FIG. 1 shows an evacuation system having escape identification lights 1, monitoring sensors 2 in the form of fire alarms or the like, and having means for activating public address devices 3, elevators 4, doors, gates 5, and communication devices 6, which are all connected to a central computing system 7. In the exemplary embodiment shown, the central computing system comprises three computers 8, 9, 10 networked with one another via an interface 11, one each for the activation of the escape identification lights 1, the monitoring sensors 2, and building devices 12. The central computing system 7 analyzes data from the monitoring sensors 2 and alternately releases or blocks the escape routes as a function thereof by targeted activation of building devices 12 and escape identification lights 1.

The escape identification lights 2 comprise a control unit 15, which may be coupled to a display 13 and is connected via a network 14 to the computing system 7, which is alternately coupled to one or to at least two displays 13 via interfaces 16 for activation. Each control unit 15 is connected via the computing system 7 and the network 14 to at least one control computer 17 for monitoring and programming, a unique network identification being assigned to each control unit 15 and each display 13. The control computers 17 may be connected to one another via a network.

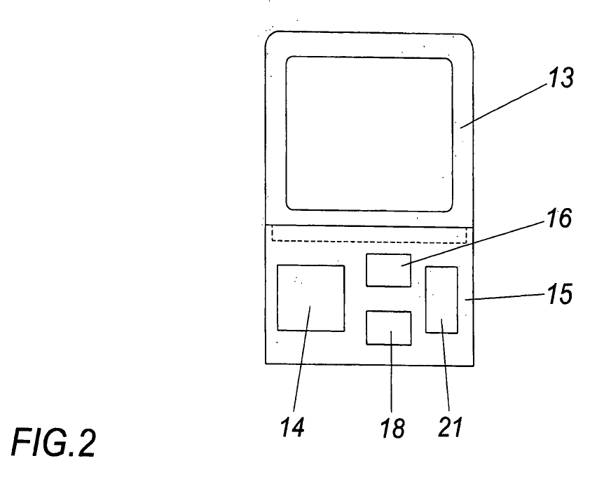

As indicated in FIG. 2, the displays 13 and the control unit 15 form a module removably connected to one another, by which it is alternately possible to install the display 13 and control unit 15 jointly or use a central control unit 15 for multiple displays 13, without having to accept an increased construction outlay.

The control unit 15 has a processor including interface 18, network interfaces 14 (parallel, serial, ethernet, or the like), a clock 19, at least one memory 20, as well as a power supply unit 21 having an emergency running device in the form of a battery 22. A camera 23, acoustic input and output devices 24, and possibly additional lights 25 are also connected via suitable interfaces 26 and/or amplifiers 27 to the network interface 14. The possibility thus exists of relaying image material from the escape routes to an operator and/or illuminating the escape route or relaying information to fleeing individuals and/or accepting information from them.

Improved alarm execution and targeted escape route guiding during evacuation as well as direct communication with individuals in affected building areas are possible with the present invention. By monitoring via video and/or acoustic monitoring, superfluous evacuations may be avoided as much as possible. Fundamentally, of course, the possibility exists of combining the dynamic escape route guiding according to the present invention with conventional emergency lighting, in particular for areas in which only one escape direction is possible.

In case of alarm, the monitoring sensors 2 (fire, gas, smoke alarms or the like) communicate the alarm, while specifying their network identification, to the central computing system 7, which, on the basis of the alarm data, such as type and location, blocks or releases escape routes in a targeted way by activating building devices 12 and rescue identifications 1, to guide individuals away from the danger point. The data connection between escape identification lights 1 and computing system 7 may differ depending on the specification. It is particularly advantageous to keep secure escape routes free in a targeted way for the most rapid possible access of rescue personnel. Depending on the activation, the escape identification lights release a pathway, block it, and/or point individuals in one or another direction.

1. An evacuation system having escape identification lights (1) and monitoring sensors (2), having a central computing system (7), which analyzes messages from the monitoring sensors (2) and alternately releases or blocks escape routes as a function thereof by targeted activation of building devices (12) and escape identification lights (1), wherein the escape identification lights (1) comprise a control unit (15), which may be coupled to a display (13) and is connected via a network (14) to the computing system (7), and which is alternately connected to one or to at least two displays (13) via interfaces (16) for activation.

2. The evacuation system according to claim 1, wherein the control unit (15) is connected via the computing system (7) and the network (14) to at least one control computer (17) for monitoring and programming and a unique network identification is assigned to each control unit (15) and each display (13).

3. An escape identification light for use in an evacuation system according to claim 1, wherein a control unit (15), which may be coupled to a display (13) and is connected via a network (14) to the computing system (17), and which is connected alternately to one or to at least two displays (13) via interfaces (16) for activation.

4. The escape identification light according to claim 3, wherein display (13) and control unit (15) form a module removably connected to one another.

5. The escape identification light according to claim 3, wherein the control unit (15) has a processor (18), a network interface (14), and a power supply unit (21) having emergency running device (22).

6. The escape identification light according to claim 3, wherein a camera (23) is provided, whose output signal is connected via the control unit to the network interface (14).

7. The escape identification light according to claim 3, wherein an acoustic input and/or output device (24) is provided, whose output signal is connected via the control unit to the network interface (14).

8. The escape identification light according to claim 3, wherein additional lamps (25) are provided on the display (13) or on the housing for illuminating the escape routes.

9. The escape identification light according to claim 8, wherein the lamps (25) include a controller for presetting the luminous intensity.

10. The escape identification light according to claim 3, wherein the control unit (15) includes a diagnostic program which sends error messages with specification of network identification and error via the network interface (14) in the event of malfunctions.
